(19) United States
(12) Patent Application Publication
(10) Pub. No.: US 2019/0247853 A1
(43) Pub. Date: Aug. 15, 2019

(54) IMPROVEMENTS IN OR RELATING TO SAMPLE LOADING INTO A MICROFLUIDIC DEVICE

(71) Applicant: FLUIDIC ANALYTICS LIMITED, Cambridge (GB)

(72) Inventors: Anthony Douglas, Cambridge (GB); Thomas Mueller, Cambridge (GB); Tuomas Pertti Jonathan Knowles, Cambridge (GB)

(73) Assignee: Fluidic Analytics Limited, Cambridge (GB)

(21) Appl. No.: 16/311,392

(22) PCT Filed: Jun. 26, 2017
(86) PCT No.: PCT/GB2017/051862

§ 371 Date: Dec. 19, 2018

(30) Foreign Application Priority Data
Jun. 27, 2016 (GB) 1611110.6
Feb. 17, 2017 (GB) 1702615.4

(51) Int. Cl. B01L 3/00

(52) U.S. Cl. CPC B01L 3/502715; B01L 2200/027; B01L 2400/049; B01L 2400/0406; B01L 2400/0487; B01L 2300/165

(57) ABSTRACT

A pedestal for loading a sample into a microfluidic device is provided. The pedestal comprising, a surface for receiving the sample and positioning it above a port; and a side support configured to provide a liquid barrier by the action of surface tension.

This invention relates to improvements in or relating to sample loading into a microfluidic device. In particular, the invention relates to loading low liquid volumes into a microfluidic device. Within the context of this invention, a microfluidic device should be understood to be a device having one or more fluidic pathways having a height or width of 1 mm or less.

Analysing samples within a microfluidic device can be advantageous as such analysis can take place when only small volumes of the sample are available, typically in the sub-microlitre or microliter range. However, loading small volumes with hand-held pipettes into a microfluidic device presents many challenges. If an entry well is optimised for loading small volumes in the range of 0.5 μL to 2 μL, larger samples of over 2 μL can easily overspill and wet away from the intended location.

Conversely, large sample entry wells are good for liquid samples which exceed 2 μL, but these smaller liquid samples of less than 2 μL can be dispensed in a poor position or wet away from the intended location. This can result in both sample wastage and complete failure of loading the sample into the microfluidic device.

Surface treatments and coatings on microfluidic devices can be used to improve the loading of small liquid samples, as can the use of capillary channels, which may be used to efficiently transport liquids into microfluidic devices by capillary action.

However, surface treatments and capillary channels can be expensive to implement on microfluidic devices. Furthermore, surface treatments and coatings can cause sample contamination.

It is against this background that the invention has arisen.

According to the present invention there is provided, a pedestal for loading a sample into a microfluidic device, the pedestal comprising a surface for receiving the sample and positioning it above a port and; a side support configured to provide a liquid barrier. The side support is angled to the receiving surface such that the liquid will not wet onto the support surface if the sample is either too large or too badly centred to sit neatly above the port. The side support cuts away from the receiving surface in order to provide a liquid barrier and prevent the sample from wetting away from the port. The side support may cut away at an obtuse angle, i.e. less than 180° to the receiving surface, although preferably the side support is provided at an angle of up to 90° to the receiving surface to prevent sample wetting. In some embodiments, the side support is provided at an acute angle to the receiving surface.

As used herein and unless otherwise specified, the term “pedestal” refers to a configuration capable of separating or elevating a receiving surface above the surrounding surfaces thereby substantially reducing sample wetting. The pedestal typically includes a receiving surface and one or more side supports. The side supports extend away from the receiving surface, often orthogonally from the receiving surface, in order to isolate the receiving surface and avoid sample wetting. The side supports may be formed into a stem which extends orthogonally from the receiving surface. The stem may have a circular cross section or it may have a polygonal cross section, for example a triangular, square or rectangular cross section. The stem may taper gradually from the edge of the receiving surface. Alternatively, the stem may have a substantially constant cross sectional area and be separate from the side support which extends away from the receiving surface.

The receiving surface may be a conical surface. The conical shape of the receiving surface will provide a dual function of holding the sample above the port and also guiding the user to position the pipette correctly when dispensing the sample. Alternatively, or additionally, the receiving surface is shaped to provide a recess capable of holding a sample. The recess may be formed from one or more sloped or concave surfaces. The recess may be regular, for example the conical shape mentioned above, or it may be an irregular shape. The angle of inclination will influence the volume of the recess created. The practical volume of the recess will also depend on the nature of the sample as a very viscous sample may bead and enable a larger volume of sample to be retained than the volume of the recess.

The sample can be a liquid sample. Alternatively, the sample may be a suspension, emulsion or a mixture. In some embodiments, the sample can be a low volume liquid sample, preferably in the sub-microlitre or microlitre range. In some embodiments, the volume may be between 0.1 to 25 μL or it may exceed 0.5, 2.5, 7.5, 10 or 15 μL. In some embodiments, the volume of the sample may be less than 25, 15, 7.5, 2.5 or 1 μL. Preferably, the volume of the sample is between 0.5 μL to 10 μL.

In some embodiments, the receiving surface may have a diameter of between 1 to 5 mm or it may exceed 1, 2, 3 or 4 mm. In some embodiments, the diameter of the receiving surface may be less than 5, 4, 2 or 1 mm. Preferably, the receiving surface is between 1 mm to 3 mm in diameter.

In some embodiments, the height of the side support may be between 100 μm to 2 mm or it may exceed 100 μm, 500 μm, 1 mm, 2 mm, 4 mm or 8 mm. In some embodiments, the height of the side support may be less than 10 mm, 8 mm, 4 mm, 2 mm, 1 mm, 500 μm or 200 μm.

By using the pedestal as disclosed in this invention, small volumes of the sample can be accurately and reliably loaded using a hand-held pipette into the microfluidic device. In contrast, traditional conical and square entry wells are less reliable for loading samples in the range of 0.5 to 10 μL, as the sample can overspill and wet away from the port.

Furthermore, the receiving surface may be at a suitable angle relative to the port for guiding the pipette delivering the sample, receiving the sample and holding the sample above the port, in order to avoid the internal corners of the pedestal where the liquid sample can be trapped.

In some embodiments, the side support is configured to provide a liquid barrier. The side support may have a vertical or near-vertical perimeter, which can enable the side support to contact the surface of the liquid sample. As a consequence, there is a contact angle between the side support and the surface of the sample, which could lead to the creation of a liquid barrier through surface tension. The creation of the liquid barrier by surface tension is advantageous because it may provide a means to avoid sample wetting away from the port. Therefore, the creation of a liquid barrier by surface tension may increase the effective volume capacity of the pedestal.

In some embodiments, the sample may be blown into the microfluidic device using pressure. Preferably, the sample is injected into the microfluidic device using pneumatic pressure.

In some embodiments, the sample may be sucked into the microfluidic device using a vacuum.

In a second aspect of the invention, there is provided a microfluidic device comprising a pedestal according to the previous aspect of the invention. The use of such microfluidic devices may be sufficient to allow small volumes of a sample, typically less than 10 μL, to be analysed.

The invention will now be further and more particularly described, by way of example only, and with reference to the accompanying drawings, in which:

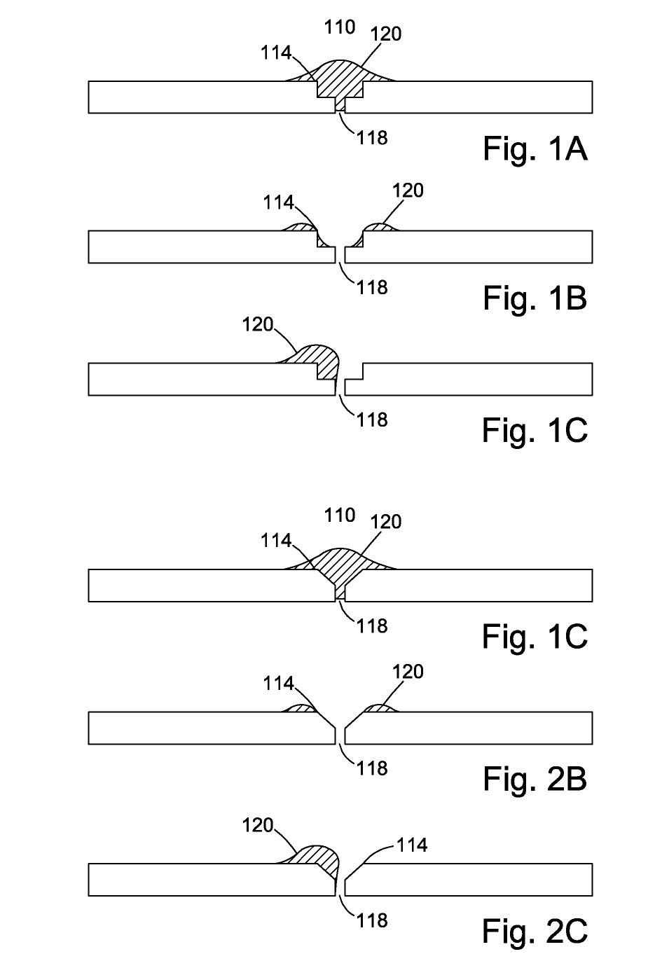

FIGS. 1A-C, 2A-C and 3 illustrate the state of the art;

FIG. 1A shows a sample being dispensed onto a well with some overspill because the sample is large in comparison with the well size,

FIG. 1B shows some of the sample remaining on a top surface and/or in a corner of the well shown in FIG. 1A following sample blow through,

FIG. 1C shows the sample being dispensed onto one side of the well shown in FIG. 1A,

FIG. 2A shows a sample being dispensed onto a well having a conical cross section with some overspill because the sample is large in comparison with the well size,

FIG. 2B shows some of the sample remaining on the top surface and/or in the corner of the well shown in FIG. 2A following sample blow through,

FIG. 2C shows the sample being dispensed onto one side of the conical well, as shown in FIG. 2A,

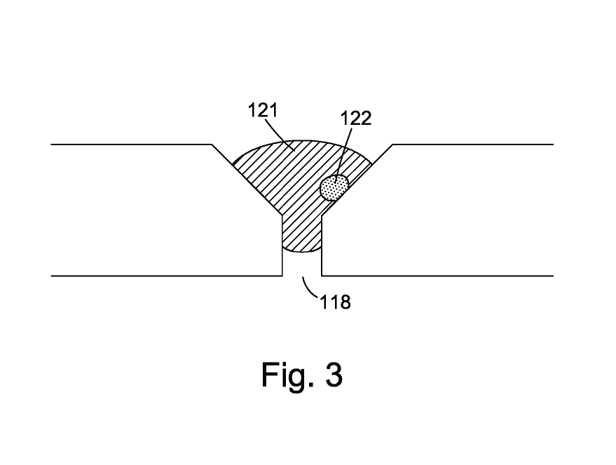

FIG. 3 shows a small sample and a large sample being dispensed onto a large well according to FIGS. 1A and 2A,

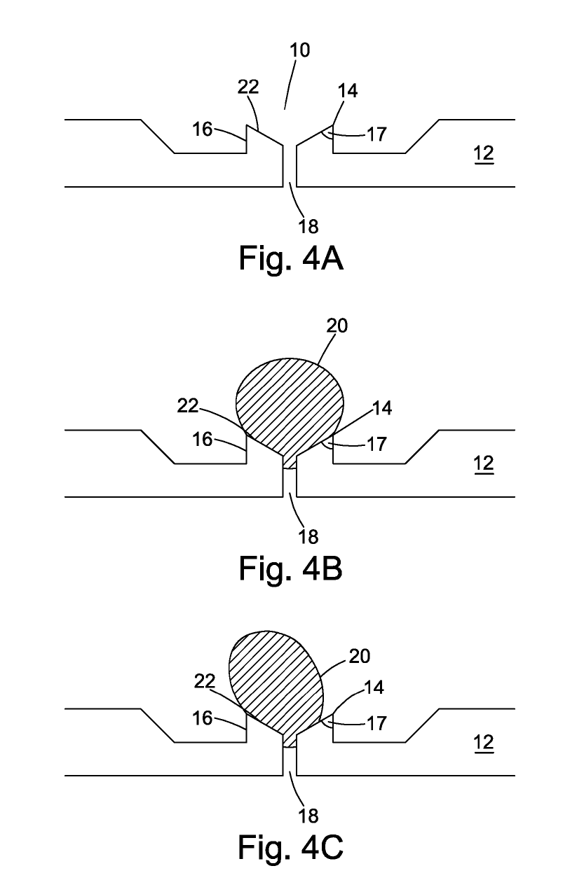

FIG. 4A provides an illustration of a pedestal according to the present invention,

FIG. 4B shows a large sample being dispensed onto the pedestal as shown in FIG. 4A,

FIG. 4C shows the sample being dispensed onto one side of the pedestal,

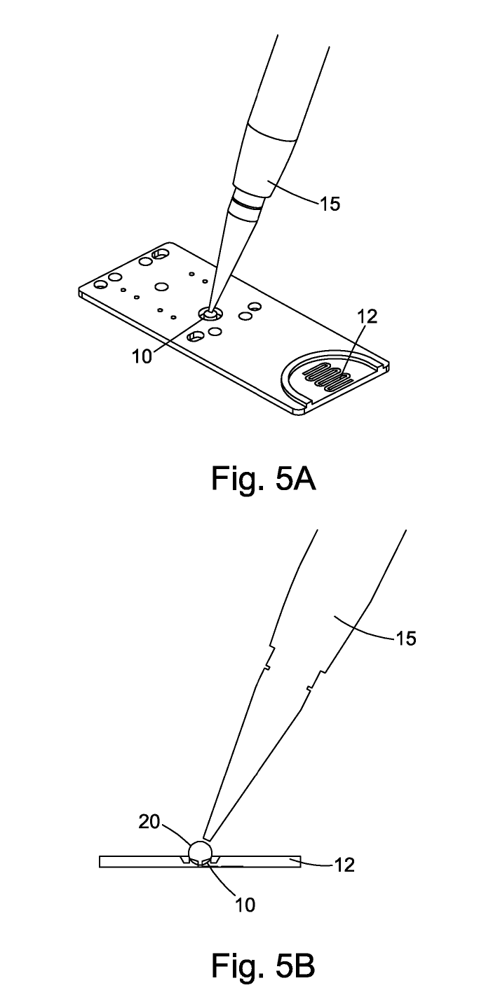

FIG. 5A shows the pedestal of FIGS. 4A to 4C in the context of a microfluidic device,

FIG. 5B shows a cross section through the device of FIG. 5A as a sample is pipetted onto the pedestal,

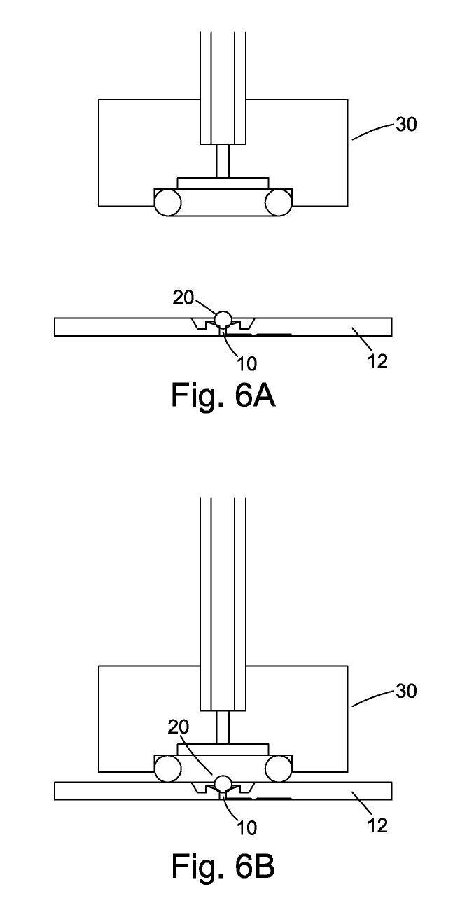

FIG. 6A shows a pneumatic assembly and the sample on top of the pedestal within a microfluidic device as shown in FIG. 5B,

FIG. 6B provides an illustration of the sample being blown into the microfluidic device, as shown in FIG. 5A,

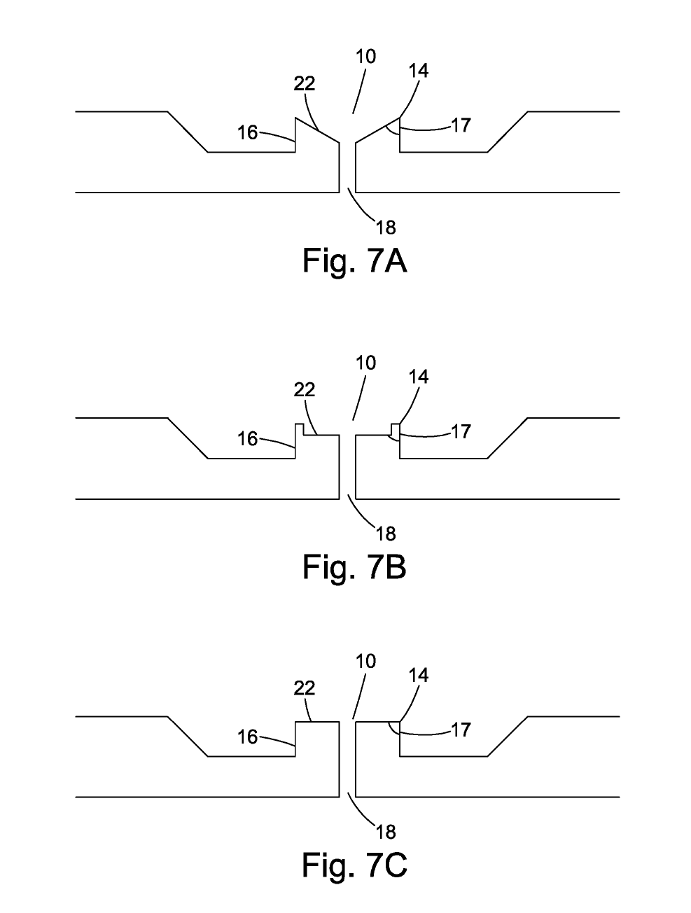

FIG. 7A shows a conical shaped pedestal according to FIGS. 4A to 4C,

FIG. 7B shows a recessed shaped pedestal and,

FIG. 7C shows a flat shaped pedestal.

Referring to FIGS. 1A, 1B, 1C, 2A, 2B and 2C, there is shown a sample 120 being dispensed onto a surface of a traditional well 110. As illustrated in FIGS. 1A and 2A, the surface 114 of the traditional well may be a circular, square or a conical surface. By dispensing the sample and in particular, a large liquid sample 120 onto the surface 114 of the traditional well 110, the sample can easily wet away from the intended location. This can result in air bubbles becoming entrained with a liquid sample. Furthermore, it can result in sample wastage.

Following an injection of the sample into a device, for example a microfluidic device, some of the sample 120 remains on top of the surface 114 of the traditional well and/or in a corner of the well, as shown in FIGS. 1B and 2B. The failure to load the entire sample into the device when using the traditional wells of FIGS. 1A to 2C may result air bubbles becoming entrained in that part of the sample that is successfully introduced into the microfluidic device and the wastage of that part of the sample which remains outside the device.

Furthermore, the sample can be dispensed in a poor position on the surface 114 of the traditional well 110. An example of a poor position is shown in FIGS. 1C and 2C, whereby the sample can be dispensed onto one side of the surface of the traditional well such that the sample does not cover an entry port 118. Consequently, this may result in a failure to inject the sample into the microfluidic device.

Referring to FIG. 3, there is shown a small sample and/or a large sample being dispensed onto the surface of a large traditional well. As shown in FIG. 3, the large well provides a capacity to receive the large sample 121 without the sample wetting away from the entry port 118. However, small samples 122 that are being dispensed onto one side of the surface of the traditional well may not cover the entry port 118 to the device, as illustrated in FIG. 3.

The present invention provides a pedestal for loading a sample, typically for loading a liquid sample into a microfluidic device.

Referring to FIGS. 4A, 4B and 4C, there is shown a pedestal 10 for loading a sample 20 into a microfluidic device 12. The pedestal comprises a receiving surface 14, such as a conical surface as shown in FIGS. 4A and 7A, and a side support 16. The receiving surface 14 is provided for receiving the sample and positioning it above a port 18. In some embodiments, such as the embodiment illustrated in FIG. 4A, it provides a recessed surface which is suitably shaped to provide a recess capable of holding a sample that has a volume of 0.1 μL to 25 μL. The port 18 can be an entry port of the microfluidic device 12. The side support 16 is provided at an acute angle 17 to the receiving surface 14 to prevent sample wetting. In some embodiments the side support 16 is orthogonal to the receiving surface 14, as shown in FIGS. 7B and 7C. This configuration will also reduce wetting.

As shown in FIGS. 4A, 4B, 4C, 5A, 5B, 6A and 6B, the sample is a liquid sample 20, which can be dispensed on top of the receiving surface 14, by a pipette 15. Usually, the sample can be dispensed on top of the receiving surface by a hand-held pipette to cover the entry port 18. Alternatively, the sample can be pipetted onto one side of the receiving surface, as shown in FIG. 4C, to cover the entry port. The liquid sample 20 may be a low volume sample for example; the liquid sample 20 may be in the range of 2 μL to 10 μL.

As illustrated in FIGS. 4A, 4B, 4C and FIGS. 5A and 5B, the receiving surface 14 is provided with a substantially slanted edge 22, which is angled towards the entry port 18. The slanted edge 22 of the receiving surface 14 guides the pipette tip from which the sample is dispensed. The liquid sample 20 is pipetted on top of the receiving surface 14, as shown in FIG. 5B. In addition, the receiving surface 14 of the pedestal shown in FIG. 4A may provide a limited surface area. The limited surface area of the conical surface 14 ensures that the dispensed liquid sample 20 fully covers the entry port 18.

The side support 16 is provided at an acute angle 17 towards the receiving surface 14. Typically, the acute angle 17 towards the receiving surface 14 may be less than 90 degree, or the acute angle 17 may exceed 5, 10, 15, 30 or 60 degrees. Preferably, the acute angle 17 provided towards the receiving surface 14 may be less than 180, 145, 90, 60, 30, 15, 10 or 5 degrees.

In one example, the side support 16 may be configured to provide a liquid barrier. As shown in FIGS. 4A, 4B and 4C, the side support 16 has a vertical or near-vertical perimeter, which enables the side support to contact the surface of the liquid sample. A contact angle can arise between the side support and the surface of the liquid sample, to create a liquid barrier through surface tension, which may provide a method for avoiding sample wetting.

Moreover, the contact angle and surface tension of the liquid sample 20 may hold a larger volume of the sample 20 on the pedestal 10, as illustrated in FIGS. 4A, 4B and 4C.

The vertical or near-vertical perimeter of the side support 16 in combination with the surface tension of the liquid sample 20 may increase the capacity for a larger volume to be loaded onto the pedestal 10. This may lead to a higher proportion of the sample 20 being blown into the microfluidic device 12. As a result, this may prevent air or bubbles from entering into the microfluidic device 12.

Referring to FIG. 6A, once the liquid sample 20 is dispensed onto the pedestal 10, the pedestal is then loaded into the microfluidic device 12, or it may alternatively be loaded into an analytical device such as a diagnostic device for analysis. As illustrated in FIG. 6B, a pneumatic assembly 30 is lowered onto the microfluidic device and may be sealed with an O-ring.

The sample 20 can be blown into the microfluidic device 12 using pressure. Preferably, the liquid sample 20 is blown into the microfluidic device 12 using pneumatic pressure. Optionally, the sample may be sucked into the microfluidic device 12 using a vacuum.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1. A pedestal for loading a sample into a microfluidic device, the pedestal comprising:
a conical surface for receiving the sample and positioning it above a port; and
a side support configured to provide a liquid barrier by the action of surface tension.

2. The pedestal according to claim 1, wherein the side support is provided at an angle of up to 90° to the receiving surface to prevent sample wetting.

3. The pedestal according to claim 1, wherein the side support is provided at an acute angle to the receiving surface.

4. (canceled)

5. The pedestal according to claim 1, wherein the receiving surface is shaped to provide a recess capable of holding a sample that has a volume of 0.1 μL to 25 μL.

6. The pedestal according to claim 1, wherein the side support has a vertical perimeter.

7. (canceled)

8. The pedestal according to claim 1, wherein the pedestal is configured such that the sample is injected into the microfluidic device using pressure.

9. The pedestal according to claim 8, wherein the pressure is pneumatic.

10. The pedestal according to claim 8, wherein the pedestal is configured such that the sample is sucked into the microfluidic device using a vacuum.

11. A microfluidic device comprising the pedestal according to claim 1.

12. The pedestal according to claim 3, wherein the receiving surface is shaped to provide a recess capable of holding a sample that has a volume of 0.1 μL to 25 μL.

13. The pedestal according to claim 6, wherein the receiving surface is shaped to provide a recess capable of holding a sample that has a volume of 0.1 μL to 25 μL.

14. A microfluidic device comprising the pedestal according to claim 12.

15. A microfluidic device comprising the pedestal according to claim 13.
